(19) United States
(12) Patent Application Publication
(10) Pub. No.: US 2016/0194049 A1
(43) Pub. Date: Jul. 7, 2016

(54) Forward and backward speed adjusting handle for electric vehicle and electric vehicle power control device

(71) Applicant: NANJING VMOTO CO., LTD., Nanjing, Jiangsu (CN)

(72) Inventors: Jiqun Jing, Nanjing, Jiangsu (CN); Baoguo Weng, Nanjing, Jiangsu (CN)

(21) Appl. No.: 14/902,594

(22) PCT Filed: Jul. 23, 2014
(86) PCT No.: PCT/CN2014/082858

§ 371 Date: Jan. 4, 2016

(30) Foreign Application Priority Data
Jul. 24, 2013 (CN) 201310312066.X
Oct. 9, 2013 (CN) 201310466272.6

(51) Int. Cl. B62K 23/04

(52) U.S. Cl. CPC B62K 23/04

(57) ABSTRACT

A forward and backward speed adjusting handle for an electric vehicle includes a bar handle, a fixing element formed by a handle seat, and a twist grip. A leftward rotation spring and a rightward rotation spring are provided between the fixing element and the twist grip. The leftward rotation spring drives the twist grip to rotate counter-clockwise relative to the bar handle; the rightward rotation spring drives the twist grip to rotate clockwise relative to the bar handle. Under a common effect of the two springs, the twist grip is at an idle position. When the twist grip is applied with an external force, the twist grip is rotated away from the idle position. A Hall-effect sensor and an arc permanent magnet are respectively provided on the twist grip and the fixing element. When the twist grip is rotated, the Hall-effect sensor moves relative to the arc permanent magnet.

### CROSS REFERENCE OF RELATED APPLICATION

This is a U.S. National Stage under 35 U.S.C 371 of the International Application PCT/CN2014/082858, filed Jul. 23, 2014, which claims priority under 35 U.S.C. 119(a-d) to CN 201310312066.X, filed Jul. 24, 2013, and to CN 201310466272.6, filed Oct. 9, 2013.

### BACKGROUND OF THE PRESENT INVENTION

1. Field of Invention

The present invention relates to a technical field of automatic control, and more particularly to a forward and backward speed adjusting handle for electric vehicles and an electric vehicle power control device comprising the speed adjusting handle.

2. Description of Related Arts

The conventional electric vehicle, comprising the electric bicycle with two wheels or three wheels and the electric motorcycle with two wheels or three wheels, generally comprises the motor for driving the electric vehicle, the controller for controlling the motor, the speed adjusting handle and the reversing switch for controlling the motion direction and the motion speed. The speed adjusting handle comprises the bar handle, the handle seat mounted on the bar handle, and the twist grip rotatably provided on the bar handle. Without applying any external force on the twist grip, the twist grip is at the idle position. By applying the external force on the twist grip, the twist grip is only able to rotate towards one direction away from the idle position, usually counter-clockwise, instead of rotating towards the opposite direction.

The reversing switch is provided on the handle seat and electrically connected to the controller. When the electric vehicle is moving forward, the rider merely needs to rotate the twist grip, and accordingly the controller controls the motor to operate under different powers according to the rotation angle of the twist grip, namely the distance of the twist grip away from the idle position. Generally, the larger rotation angle (the further the twist grip away from the idle position), the larger forward torque outputted by the motor to drive the electric vehicle to move forward. In order to move backward, the reversing switch is pressed down to close the reversing switch, and herein, by rotating the twist grip, the controller controls the motor to operate under different powers according to the rotation angle of the twist grip, namely the distance of the twist grip away from the idle position. Generally, the larger rotation angle (the further the twist grip away from the idle position), the larger backward torque outputted by the motor to drive the electric vehicle to move backward. The damage of the reversing switch or the poor contact of the reversing switch with the wiring harness of the controller may cause incorrect motion direction and thus the danger. In order to improve the reliability, the reversing switch usually adopts the relatively expensive imported device, which increases the vehicle costs.

Besides, it is difficult for the rider to accomplish braking with the conventional speed adjusting handle. In order to brake and stop the electric vehicle which is moving forward, the motor needs to output the backward torque, towards the direction opposite to the direction of the output torque of the motor which drives the electric vehicle to move forward. Therefore, the rider is required to press down the reversing switch and simultaneously rotate the twist grip, thereby generating the backward torque by the motor and braking the motor and the electric vehicle (gradually slowing down the rotation of the motor). Pressing down the reversing switch and simultaneously rotating the twist grip are inconvenient in operation and it is highly likely to make mistakes.

A removal of the reversing switch not only saves the costs, but also reduces the danger. The removal of the reversing switch necessitates a modification of the conventional speed adjusting handle; however, if the speed adjusting handle after the modification (a speed adjusting handle capable of rotating the twist grip to control the motor to rotate forward and backward, without reversing switch) is more expensive than the conventional speed adjusting handle minus the price of the reversing switch, it is undoubtedly difficult to promote the application of the speed adjusting handle after the modification. Therefore, it is necessary to modify the conventional speed adjusting handle to obtain a simple structure, low manufacture costs and assembling costs, and high reliability.

### SUMMARY OF THE PRESENT INVENTION

An object of the present invention is to provide a forward and backward speed adjusting handle for electric vehicles, the forward and backward speed adjusting handle capable of rotating forward and backward to control the electric vehicle to move forward and backward. The forward and backward speed adjusting handle of the present invention has a simple structure, convenient operations and high reliability, omits reversing switch, and has costs equivalent to a conventional speed adjusting handle.

A forward and backward speed adjusting handle for electric vehicles, comprises a bar handle, a fixing element formed by a handle seat mounted on the bar handle, a twist grip rotatably provided on the bar handle, a leftward rotation spring and a rightward rotation spring provided between the fixing element and the twist grip, wherein: the leftward rotation spring is for rotating the twist grip counter-clockwise relative to the bar handle; the rightward rotation spring is for rotating the twist grip clockwise relative to the bar handle; under a common effect of the leftward rotation spring and the rightward rotation spring, the twist grip is at an idle position; when the twist grip is exerted with external force, the twist grip rotates clockwise or counter-clockwise away from the idle position; and

further comprises a Hall-effect sensor and an arc permanent magnet which are respectively provided on the twist grip and the fixing element, facing against each other but without contact, wherein: when the twist grip rotates, the Hall-effect sensor moves relative to the arc permanent magnet, detects different positions of the arc permanent magnet, and accordingly outputs different signals.

The present invention has the following benefits. In operation, the Hall-effect sensor is electrically connected to a controller. The controller regards an output signal of the Hall-effect sensor, when the twist grip is at the idle position, as a reference signal. When the twist grip rotates away from the idle position towards a first direction, such as counter-clockwise, the output signal of the Hall-effect sensor becomes larger than the reference signal (the output signal of the Hall-effect sensor may be smaller than the reference signal, but is illustrated herein to be larger, just for convenience), and increases along with an increase of a rotation angle of the twist grip (relative to the idle position). When the twist grip rotates away from the idle position towards a second direction opposite to the first direction, the output signal of the Hall-effect sensor becomes smaller than the reference signal, and decreases along with the increase of the rotation angle of the twist grip (relative to the idle position). The controller controls the motor according to the output signal of the Hall-effect sensor. When the Hall-effect sensor outputs the reference signal, the motor outputs no torque under the control of the controller and maintains an initial state (for example, the motor neither rotates forward nor rotates backward). When the output signal of the Hall-effect sensor is larger than the reference signal, the motor outputs a counter-clockwise torque under the control of the controller (the motor may output a clockwise torque, and is illustrated to output the counter-clockwise torque, just for convenience); the counter-clockwise torque outputted by the motor increases with an increase of the output signal of the Hall-effect sensor, which drives the motor to rotate forward (the motor may rotate backward, and is illustrated to rotate forward, just for convenience). When the output signal of the Hall-effect sensor is smaller than the reference signal, the motor outputs the clockwise torque under the control of the controller; the clockwise torque outputted by the motor increases with a decrease of the output signal of the Hall-effect sensor, which drives the motor to rotate backward. If the initial state of the motor is rotating forward, in order to brake, the twist grip is so rotated that the output signal of the Hall-effect sensor is smaller than the reference signal; under the control of the controller, the motor outputs the clockwise torque, wherein a direction of the clockwise torque is opposite to a direction of the motor rotating forward, and thus the motor gradually stops rotating forward (gradually slowing down). If it is intended to rapidly brake the motor which has the initial state of rotating forward, the twist grip is so rotated that the Hall-effect sensor outputs smaller signal, and accordingly the motor outputs larger clockwise torque. Therefore, it is realized to control the motor to rotate forward and backward, and to control the electric vehicle to move forward, move backward and brake,

Through cooperation between the arc permanent magnet and the Hall-effect sensor, with the relatively long permanent magnet (arc length), a range of the output signal of the Hall-effect sensor is relatively large. Therefore, even though the twist grip of each speed adjusting handle in massive production may not have exactly the same idle position, changes of the output signal of the Hall-effect sensor, caused by different idle positions of the twist grips, are still within a margin of error of the output signal of the Hall-effect sensor. Therefore, the reference signal outputted by the Hall-effect sensor of each speed adjusting handle is basically the same.

The speed adjusting handle comprises the two springs, the leftward rotation spring and the rightward rotation spring, while an ordinary speed adjusting handle has merely one spring; the speed adjusting handle omits the reversing switch. Therefore, the speed adjusting handle of the present invention has almost the same costs with the ordinary speed adjusting handle. The speed adjusting handle of the present invention has the simple structure and the convenient assembling. The speed adjusting handle of the present invention has a low accuracy requirement on assembled positions of the arc permanent magnet and the Hall-effect sensor, needless of any special alignment about a relative position between the arc permanent magnet and the Hall-effect sensor. The speed adjusting handle of the present invention has relatively low manufacture costs and assembling costs, and is able to control the electric vehicle to move forward and backward by rotating forward and backward.

In the speed adjusting handle of the present invention, the arc permanent magnet is coaxial with the twist grip; one of the arc permanent magnet and the Hall-effect sensor is provided at an end face of the twist grip, and the other one of the arc permanent magnet and the Hall-effect sensor is provided on the handle seat; the Hall-effect sensor and the arc permanent magnet are faced against each other in a direction parallel with an axis of the twist grip.

In the speed adjusting handle of the present invention, the arc permanent magnet is coaxial with the twist grip; one of the arc permanent magnet and the Hall-effect sensor is provided at an outer periphery of the twist grip, and the other one of the arc permanent magnet and the Hall-effect sensor is provided on the handle seat; the Hall-effect sensor and the arc permanent magnet are faced against each other in a direction vertical to the axis of the twist grip.

In the speed adjusting handle of the present invention, a stiffness of the leftward rotation spring and a stiffness of the rightward rotation spring satisfy that an external force for rotating the twist grip counter-clockwise away from the idle position is smaller than an external force for rotating the twist grip clockwise away from the idle position. In other words, the counter-clockwise rotation and the clockwise rotation of the twist grip feel differently for the riders to distinguish. In most cases, the counter-clockwise rotation of the twist grip controls the electric vehicle to move forward, while the clockwise rotation of the twist grip controls the electric vehicle to move backward. Of course, the counter-clockwise rotation of the twist grip can control the electric vehicle to move backward, and accordingly the clockwise rotation of the twist grip controls the electric vehicle to move forward. In order to realize a relatively small force for rotating the twist grip to drive the electric vehicle to move forward and a relatively large force for rotating the twist grip to drive the electric vehicle to move backward, it is necessary for the leftward rotation spring and the rightward rotation spring to have different stiffness (the external force for rotating the twist grip counter-clockwise is smaller than the external force for rotating the twist grip clockwise). Besides, the bigger difference between the stiffness of the leftward rotation spring and the stiffness of the rightward rotation spring, the better. The bigger difference in the stiffness of the two springs, the smaller the external force for rotating the twist grip counter-clockwise away from the idle position compared with the external force for rotating the twist grip clockwise, and the bigger difference in the feelings of the counter-clockwise rotation and the clockwise rotation. The bigger difference in the stiffness of the two springs results in that the twist grip of each speed adjusting handle in the massive production has basically the same idle position and further ensures that the Hall-effect sensor of each speed adjusting handle outputs basically the same reference signal.

In the speed adjusting handle of the present invention, the outer periphery of the twist grip has an arc groove which is coaxial with the twist grip, wherein two inner end faces of the arc groove are at two ends in a circumferential direction of the twist grip; a spring seat is provided on the handle seat, and the leftward rotation spring is a coiled compression spring; an axis of the coiled compression spring is vertical to the axis of the twist grip; one end of the coiled compression spring is biased against the spring seat, and the other end of the coiled compression spring contacts one of the inner end faces of the arc groove. The coiled compression spring applies a force on the twist grip via the inner end face of the arc groove along a tangent direction of the twist grip (to drive the twist grip to rotate counter-clockwise), so the twist grip rotates flexibly, without being stuck.

In the speed adjusting handle of the present invention, the twist grip is at the idle position under the common effect of the two springs. Although the springs in the massive production have the substantially uniform resilience, there is still an error in the resilience of the springs, more or less. Therefore, the twist grip of each speed adjusting handle in the massive production has the idle position not exactly the same. Despite that the changes of the output signal of the Hall-effect sensor, caused by the different idle positions of the twist grips, are still within the margin of error of the output signal of the Hall-effect sensor, the reference signal outputted by the Hall-effect sensor in each speed adjusting handle may be different. Preferably, in order to overcome a possible difference in the reference signals, as a further improvement, the handle seat has a sliding groove running along a direction of the axis of the coiled compression spring, and a slider is slidably provided within the sliding groove; the sliding groove is communicated with the arc groove; a restricting element, for restricting a maximal sliding distance of the slider relative to the spring seat, is provided in the sliding groove; the two ends of the coiled compression spring are respectively biased against the spring seat and the slider. When the twist grip is at the idle position, the leftward rotation spring drives the slider to contact the restricting element, and the rightward rotation spring drives the slider to contact one of the inner end faces of the arc groove. Such a mechanical positioning that the slider contacts the restricting element and the inner end face of the arc groove at the same time, guarantees that the twist grip is reliably at the idle position, avoids the error in the idle position of the twist grip of each speed adjusting handle in the massive production caused by the error in the spring resilience, ensures exactly the same idle position of the twist grip of each speed adjusting handle, and further ensures exactly the same reference signal of the Hall-effect sensor in each speed adjusting handle. The forward and backward speed adjusting handle for the electric vehicles operates as follows. For rotating the twist grip counter-clockwise, a counter-clockwise torque (external force) is applied onto the twist grip, and then the twist grip rotates counter-clockwise against the resilience of the rightward rotation spring, wherein the slider always contacts the restricting element under the effect of the leftward rotation spring. When the external force is canceled, the twist grip rotates clockwise under the effect of the rightward rotation spring, and arrives at the idle position when the inner end surface of the arc groove contacts the slider. For rotating the twist grip clockwise, a clockwise torque (external force) is applied onto the twist grip, and then the twist grip rotates clockwise against the resilience of the leftward rotation spring; meanwhile, the inner end face of the arc groove pushes the slider, and the slider is detached from the restricting element and moves towards the spring seat within the sliding groove. When the external force is canceled, under the effect of the leftward rotation spring, the slider overcomes the resilience of the rightward rotation spring and pushes the inner end face of the arc groove to rotate counter-clockwise; the twist grip arrives at the idle position when the slider contacts the restricting element (and also the inner end face of the arc groove).

In order to ensure that the slider slides smoothly within the sliding groove, the inner end face of the arc groove which contacts the slider is a curved surface. When the twist grip is exerted with external force, the twist grip is rotated and the inner end face of the arc groove pushes the slider to move, wherein contacting points between the curved surface and the slider are at the axis of the coiled compression spring, in such a manner that an action force onto the slider by the coiled compression spring and an action force onto the slider by the inner end face of the arc groove are both in the direction of the axis of the coiled compression spring, thereby preventing the slider from turning and ensuring a smooth sliding of the slider within the sliding groove.

In order to restrict a maximal angle at which the twist grip rotates counter-clockwise and clockwise, and to improve the convenience of operation, the speed adjusting handle of the present invention further comprises a position-limiting device, for restricting the maximal angle at which the twist grip is able to rotate counter-clockwise away from the idle position and the maximal angle at which the twist grip is able to rotate clockwise away from the idle position.

The position-limiting device has various embodiments. Preferably, in one embodiment, the position-limiting device comprises an arc position-limiting groove and a position-limiting block, wherein: the handle seat has the arc position-limiting groove which is coaxial with the twist grip; two inner end faces of the arc position-limiting groove are at two ends along the circumferential direction of the twist grip; the position-limiting block which is inserted into the arc position-limiting groove along a radial direction of the twist grip is provided at the outer periphery of the twist grip; when the twist grip rotates counter-clockwise at the maximal angle away from the idle position under the external force, the position-limiting block contacts one of the two inner end faces of the arc position-limiting groove, thereby forbidding the twist grip to rotate counter-clockwise any further; when the twist grip rotates clockwise at the maximal angle away from the idle position under the external force, the position-limiting block contacts the other one of the two inner end faces of the arc position-limiting groove, thereby forbidding the twist grip to rotate clockwise any further.

Preferably, in another embodiment, the position-limiting device comprises an arc position-limiting groove and a position-limiting block, wherein: the arc position-limiting groove which is coaxial with the twist grip is provided at the outer periphery of the twist grip; two inner end faces of the arc position-limiting groove are at two ends along the circumferential direction of the twist grip; the position-limiting block which is inserted into the arc position-limiting groove along a radial direction of the twist grip is provided on the handle seat; when the twist grip rotates counter-clockwise at the maximal angle away from the idle position under the external force, the position-limiting block contacts one of the two inner end faces of the arc position-limiting groove, thereby forbidding the twist grip to rotate counter-clockwise any further; when the twist grip rotates clockwise at the maximal angle away from the idle position, the position-limiting block contacts the other one of the two inner end faces of the arc position-limiting groove, thereby forbidding the twist grip to rotate clockwise any further. In order to facilitate assembling the position-limiting block and increase a manufacture and assembling efficiency, the handle seat has a through-hole in the radial direction of the twist grip; the position-limiting block is detachably connected to the through-hole and runs into the arc position-limiting groove through the through-hole. In order to facilitate assembling the Hall-effect sensor and increase the manufacture and assembling efficiency, the arc permanent magnet is provided at the outer periphery of the twist grip; the arc permanent magnet and the arc position-limiting groove are located at different sections of the twist grip; the position-limiting block is connected to a sensor seat where the Hall-effect sensor is mounted; the position-limiting block and the Hall-effect sensor cross through the through-holes; the Hall-effect sensor and the arc permanent magnet are faced against each other in the direction vertical to the axis of the twist grip.

In the speed adjusting handle of the present invention, the twist grip is at the idle position under the common effect of the two springs. Although the springs in the massive production have the substantially uniform resilience, there is still an error in the resilience of the springs, more or less. Therefore, the twist grip of each speed adjusting handle in the massive production has the idle position not exactly the same. Despite that the changes of the output signal of the Hall-effect sensor, caused by the different idle positions of the twist grips, are still within the margin of error of the output signal of the Hall-effect sensor, the reference signal outputted by the Hall-effect sensor in each speed adjusting handle may be different. Preferably, in order to overcome a difference in the reference signals, as a further improvement, in the forward and backward speed adjusting handle for the electric vehicles, a boss is provided at the end face of the twist grip and the handle seat has a circular groove, wherein the boss is inserted into the circular groove. The circular groove is coaxial with the twist grip; a slider which is able to slide around an axis of the circular groove is provided within the circular groove; the leftward rotation spring, for pushing the slider to move counter-clockwise within the circular groove, is provided between the slider and the spring seat at a bottom of the circular groove; a reversed position-limiting barrier, for determining a limit position to which the slider is able to move counter-clockwise, is provided at a lateral wall of the circular groove; when the twist grip is at the idle position, the leftward rotation spring drives the slider to contact the reversed position-limiting barrier, and meanwhile the rightward rotation spring drives the boss to contact the slider. Such a mechanical positioning that the slider contacts the reversed position-limiting barrier and the boss at the same time ensures that the twist grip is located reliably at the idle position, avoids the error in the idle position of the twist grip of each speed adjusting handle in the massive production due to the error in the resilience of the springs, and guarantees exactly the same idle position of the twist grip of each speed adjusting handle, so as to further guarantee exactly the same reference signal of the Hall-effect sensor of each speed adjusting handle. The forward and backward speed adjusting handle for the electric vehicles operates as follows. For rotating the twist grip counter-clockwise, a counter-clockwise torque (external force) is applied onto the twist grip, and then the twist grip is rotated counter-clockwise against the resilience of the rightward rotation spring, wherein the slider always contacts the reversed position-limiting barrier under the effect of the leftward rotation spring. When the external force is canceled, the twist grip rotates clockwise under the effect of the rightward rotation spring and arrives at the idle position when the boss contacts the slider. For rotating the twist grip clockwise, a clockwise torque (external force) is applied onto the twist grip, and then the twist grip is rotated clockwise against the resilience of the leftward rotation spring; in the meantime, the boss pushes the slider, and the slider is detached from the reversed position-limiting barrier and moves clockwise within the circular groove. When the external force is canceled, under the effect of the leftward rotation spring, the slider overcomes the resilience of the rightward rotation spring and pushes the boss to move counter-clockwise within the circular groove; the twist grip arrives at the idle position when the slider contacts the reversed position-limiting barrier (and also the boss).

In the forward and backward speed adjusting handle for the electric vehicles, the slider comprises a guiding portion, slidably contacting the lateral wall of the circular groove, and a supporting portion, disposed in a radial direction of the circular groove; the spring seat is arc-shaped; the guiding portion is provided between the lateral wall of the circular groove and the spring seat, in contact with the lateral wall of the circular groove and the spring seat; the leftward rotation spring is provided between an end of the spring seat and the supporting portion. Because of the guiding portion, the slider slides flexibly within the circular groove and is prevented from being stuck within the circular groove and being disenabled to move. The supporting portion facilitates a connection to the leftward rotation spring.

In the forward and backward speed adjusting handle for the electric vehicles, a forward position-limiting barrier is provided at the bottom of the circular groove; when the twist grip rotates counter-clockwise at a certain angle away from the idle position under the external force, the forward position-limiting barrier contacts the twist grip, thereby forbidding the twist grip to rotate counter-clockwise any further; wherein the certain angle is a maximal angle at which the twist grip is able to rotate counter-clockwise away from the idle position under the external force. When the speed adjusting handle is rotating counter-clockwise, due to a restriction by the forward position-limiting barrier, the twist grip can be rotated counter-clockwise without any worry about operation. Even if the twist grip is rotated at an overlarge angle, the twist grip is restricted and stopped by the forward position-limiting barrier, facilitating the operation.

In the forward and backward speed adjusting handle for the electric vehicles, one of the leftward rotation spring and the rightward rotation spring is the coiled compression spring provided between the handle seat and the twist grip, and the other one of the leftward rotation spring and the rightward rotation spring is a torsion spring provided between the bar handle and the twist grip.

In the forward and backward speed adjusting handle for the electric vehicles, the arc permanent magnet has a central angle of more than 90°, for increasing a distance by which the arc permanent magnet is able to move relative to the Hall-effect sensor, and increasing a resolution of the output signal of the Hall-effect sensor.

In the forward and backward speed adjusting handle for the electric vehicles, the output signal of the Hall-effect sensor is a voltage signal at a range of x-y; at the idle position, the output signal of the Hall-effect sensor is around x+(y−x)/2.

In the forward and backward speed adjusting handle for the electric vehicles, the output signal of the Hall-effect sensor is a pulse width modulation signal having a duty cycle of 5%-95%; at the idle position, the output signal of the Hall-effect sensor has the duty cycle of around 50%.

The present invention further provides an electric vehicle power control device which has a simple structure, convenient operations and a high reliability.

The electric vehicle power control device of the present invention comprises: the forward and backward speed adjusting handle for the electric vehicle, and a controller for controlling a motor for driving the electric vehicle, wherein: the controller is electrically connected to the Hall-effect sensor; the controller receives the output signal of the Hall-effect sensor, and controls the motor to output the counter-clockwise torque or the clockwise torque according to different output signals of the Hall-effect sensor.

The electric vehicle power control device operates as follows. The controller regards the output signal of the Hall-effect sensor when the twist grip is at the idle position as the reference signal. When the twist grip is rotated away from the idle position towards a direction (such as counter-clockwise), the output signal of the Hall-effect sensor is larger than the reference signal (or smaller, herein illustrated to be larger for convenience), and increases along with the increase of the rotation angle of the twist grip (relative to the idle position); when the twist grip is rotated away from the idle position towards an opposite direction, the output signal of the Hall-effect sensor is smaller than the reference signal, and decreases along with the increase of the rotation angle of the twist grip (relative to the idle position). The controller controls the motor according to the output signal of the Hall-effect sensor. When the Hall-effect sensor outputs the reference signal, the motor outputs no torque under the control of the controller; and the motor maintains the initial state (for example, the motor neither rotates forward nor rotates backward); when the output signal of the Hall-effect sensor is larger than the reference signal, the motor outputs the counter-clockwise torque under the control of the controller (or the clockwise torque, herein illustrated to be the counter-clockwise torque for convenience), and the counter-clockwise torque outputted by the motor increases with the increase of the output signal of the Hall-effect sensor, so that the motor rotates forward (or backward, herein illustrated to rotate forward for convenience) to drive the electric vehicle to move forward; when the output signal of the Hall-effect sensor is smaller than the reference signal, the motor outputs the clockwise torque under the control of the controller, and the clockwise torque outputted by the motor increases along with the output signal of the Hall-effect sensor decreases, so that the motor rotates backward to drive the electric vehicle to move backward. If the initial state of the motor is rotating forward, when the electric vehicle is moving forward, in order to accomplish braking, the twist grip is so rotated that the output signal of the Hall-effect sensor is smaller than the reference signal; the motor outputs the clockwise torque under the control of the controller, wherein the direction of the clockwise torque is opposite to the direction of the motor rotating forward. As a result, the motor gradually stops rotating forward (the motor gradually slows down), the electric vehicle gradually slows down, so as to accomplish braking. If it is intended to rapidly brake the motor having the initial state of rotating forward (when the electric vehicle is moving forward), the twist grip is so rotated that the Hall-effect sensor outputs smaller signal and the motor outputs larger clockwise torque. Therefore, it is realized to control the motor to rotate forward and backward, and to control the electric vehicle to move forward, move backward and brake.

For the electric vehicle power control device, when the twist grip is at the idle position, the output signal of the Hall-effect sensor is the reference signal T. Given that the output signal of the Hall-effect sensor R when the twist grip is at some position, when T+T*5%≧R≧T−T*5%, the motor outputs no torque; a direction of the torque outputted by the motor when R>T+T*5% is opposite to a direction of the torque outputted by the motor when R<T−T*5%, a value of the torque outputted by the motor when R>T+T*5% increases along with R−(T+T*5%) increases; a value of the torque outputted by the motor when R<T−T*5% increase along with (T−T*5%)−R increases. In the massive production, the idle position of the twist grip of each speed adjusting handle may not be exactly the same due to the error in assembling, the error in the resilience of the springs, etc., which further results in that the reference signal T of each speed adjusting handle is not exactly the same. If a constant value is provided as a judgment threshold for the different torques outputted by the motor under the control of the controller, the constant value fails to match with the reference signal T of each speed adjusting handle which is not exactly the same. In order to overcome such failure, the present invention provides a value range T±T*5% which serves as the judgment threshold for the different torques outputted by the motor under the control of the controller, namely the motor outputs no torque when T+T*5%≧R≧T−T*5% and outputs torque when R>T+T*5% and R<T−T*5%. The electric vehicle power control device is applicable for the massive production with high manufacture efficiency and a high reliability. The present invention has advantages as follows. Compared with prior arts, the forward and backward speed adjusting handle for the electric vehicles, provided by the present invention, has a simple structure, low costs, high reliability, and convenient operations due to the removal of the reversing switch. Especially, it is unnecessary to press down the reversing switch and rotating the twist grip so that the output signal of the Hall-effect sensor is smaller than the reference signal at the same time, which improves the convenience and reliability of the operations of the present invention, improves security in driving the vehicle and reduces manufacture costs.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a twist grip according to a first preferred embodiment of the present invention.

FIG. 2 is a front view of the twist grip according to the first preferred embodiment of the present invention.

FIG. 3 is a right view of the twist grip according to the first preferred embodiment of the present invention (a right view of FIG. 2).

FIG. 4 is a sectional view of a speed adjusting handle at an idle position according to the first preferred embodiment of the present invention.

FIG. 5 is a sectional view of the twist grip of the speed adjusting handle, rotated counter-clockwise to a position-limiting device, according to the first preferred embodiment of the present invention.

FIG. 6 is a sectional view of the twist grip of the speed adjusting handle, rotated clockwise to the position-limiting device, according to the first preferred embodiment of the present invention.

FIG. 7 is a sketch view of a section A-A of FIG. 4.

FIG. 8 is an exploded view of the speed adjusting handle according to the first preferred embodiment of the present invention.

FIG. 9 is a sectional view of the speed adjusting handle at the idle position according to a third preferred embodiment of the present invention.

FIG. 10 is a sketch view of the speed adjusting handle according to a fourth preferred embodiment of the present invention.

FIG. 11 is a sketch view of a section B-B of FIG. 10.

FIG. 12 is an exploded view of the speed adjusting handle according to the fourth preferred embodiment of the present invention.

FIG. 13 is a first sectional view of the speed adjusting handle at the idle position according to the fourth preferred embodiment of the present invention.

FIG. 14 is a first sectional view of the twist grip of the speed adjusting handle, rotated counter-clockwise to the position-limiting device, according to the fourth preferred embodiment of the present invention.

FIG. 15 is a first sectional view of the twist grip of the speed adjusting handle, rotated clockwise to the position-limiting device, according to the fourth preferred embodiment of the present invention.

FIG. 16 is a second sectional view of the speed adjusting handle at the idle position according to the fourth preferred embodiment of the present invention.

FIG. 17 is a second sectional view of the twist grip of the speed adjusting handle, rotated counter-clockwise to the position-limiting device, according to the fourth preferred embodiment of the present invention.

FIG. 18 is a second sectional view of the twist grip of the speed adjusting handle, rotated clockwise to the position-limiting device, according to the fourth preferred embodiment of the present invention.

FIG. 19 is a sketch view of relative positions of the twist grip, a position-limiting block and a slider according to the fourth preferred embodiment of the present invention.

FIG. 20 is a perspective view of the twist grip according to the fourth preferred embodiment of the present invention.

FIG. 21 is another perspective view of the twist grip according to the fourth preferred embodiment of the present invention.

FIG. 22 is yet another perspective view of the twist grip according to the fourth preferred embodiment of the present invention.

FIG. 23 is a side elevation view of the twist grip according to the fourth preferred embodiment of the present invention.

FIG. 24 is a perspective view of a fixing element according to the fourth preferred embodiment of the present invention.

FIG. 25 is another perspective view of the fixing element according to the fourth preferred embodiment of the present invention.

FIG. 26 is yet another perspective view of the fixing element according to the fourth preferred embodiment of the present invention.

FIG. 27 is yet another perspective view of the fixing element according to the fourth preferred embodiment of the present invention.

### DETAILED DESCRIPTION OF THE PREFERRED EMBODIMENT

One skilled in the art will understand that the embodiment of the present invention as showed in the drawings and described below is exemplary only and not intended to be limiting. Its embodiments have been showed and described for the purposes of illustrating the functional and structural principles of the present invention and are subject to change without departure from such principles. Therefore, this invention includes all modifications encompassed within the spirit and scope of the following claims.

### First Preferred Embodiment

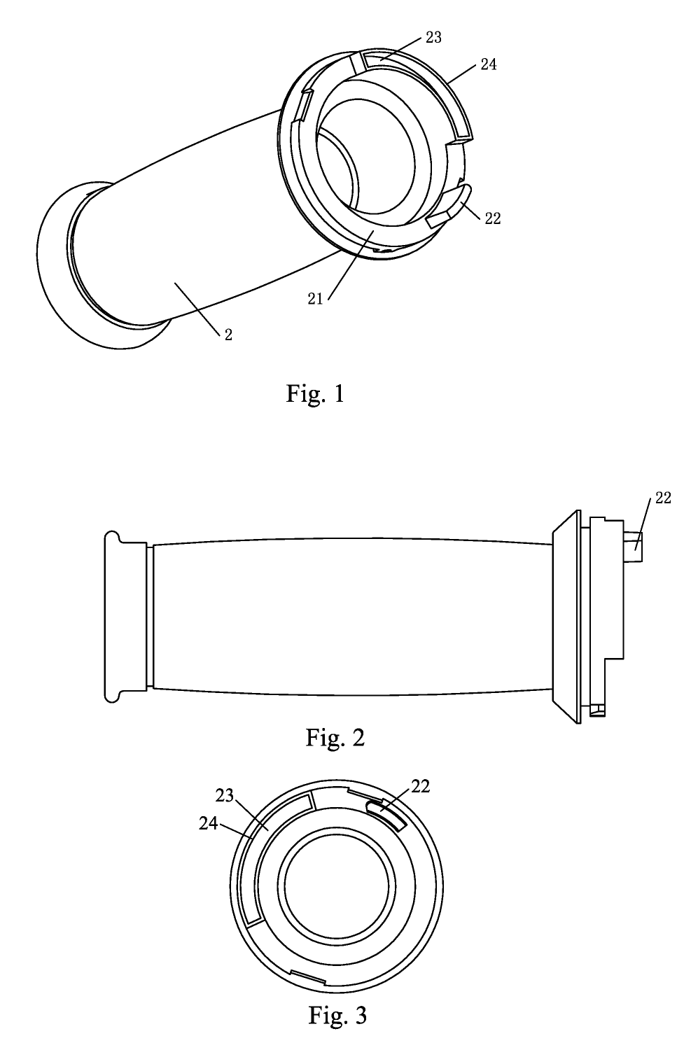

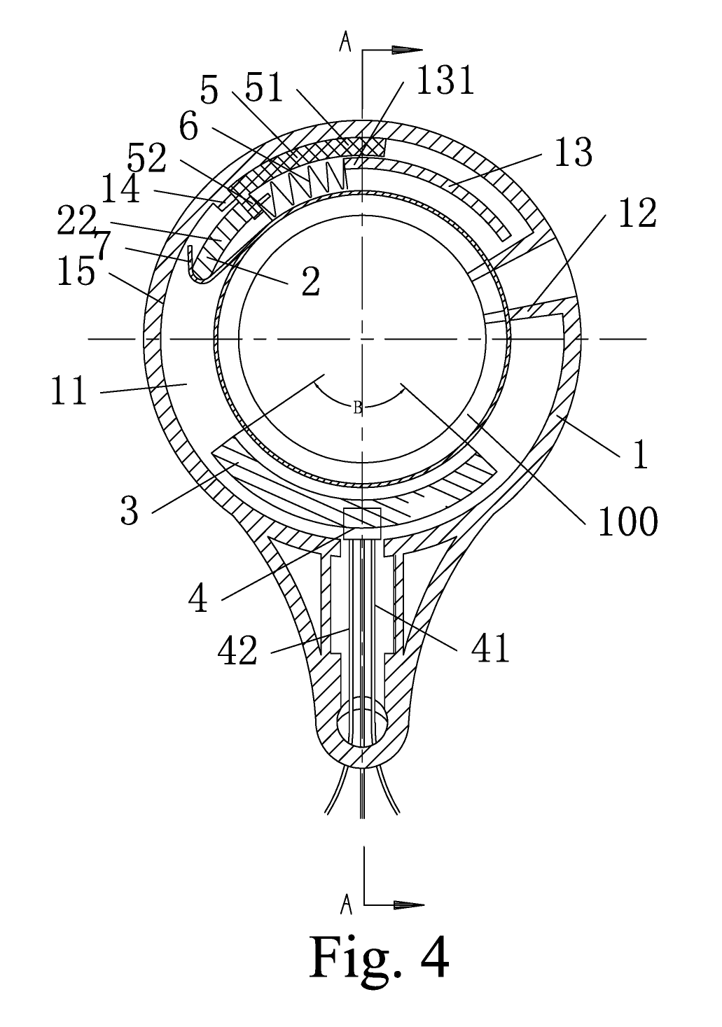

Referring to FIGS. 4-8 of the drawings, according to a first preferred embodiment of the present invention, a forward and backward speed adjusting handle for electric vehicles comprises a bar handle 100, a fixing element formed by a handle seat 1 mounted on the bar handle 100, and a twist grip 2 rotatably provided on the bar handle 100. Referring to FIGS. 1-3, a boss 22 and an arc-shaped body 24 having an arc groove 23 are provided at an end face 21 of the twist grip 2 axially facing the handle seat 1. The arc groove 23 is for containing an arc magnetic steel 3 (arc permanent magnet). The arc permanent magnet has a central angle B of around 100°.

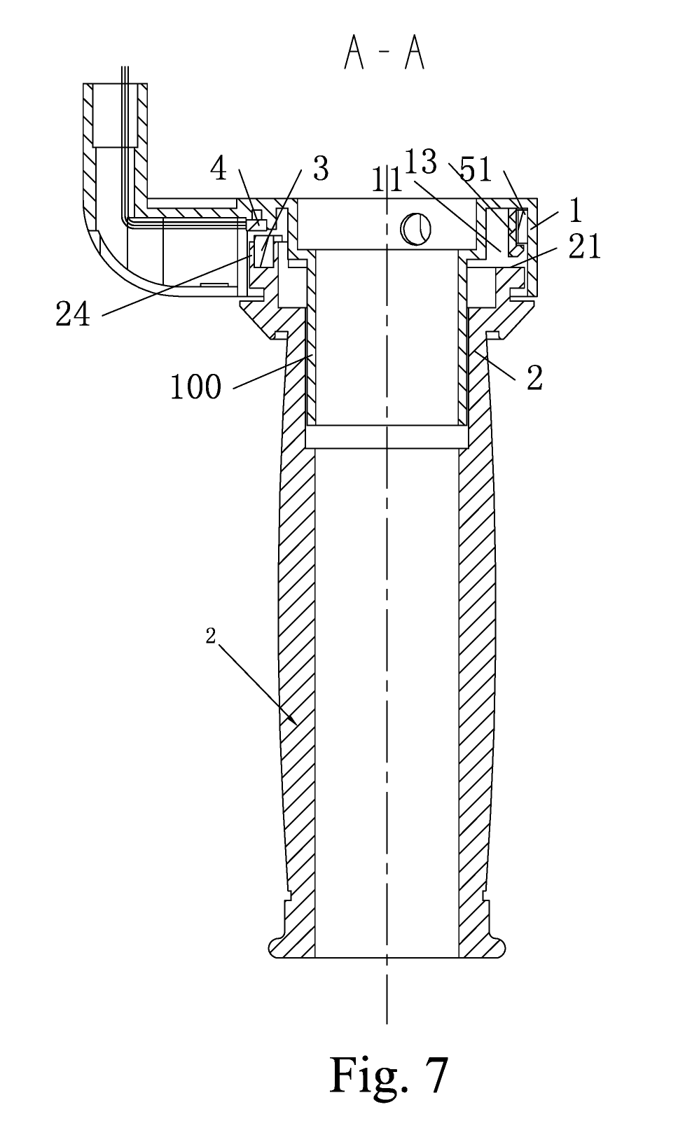

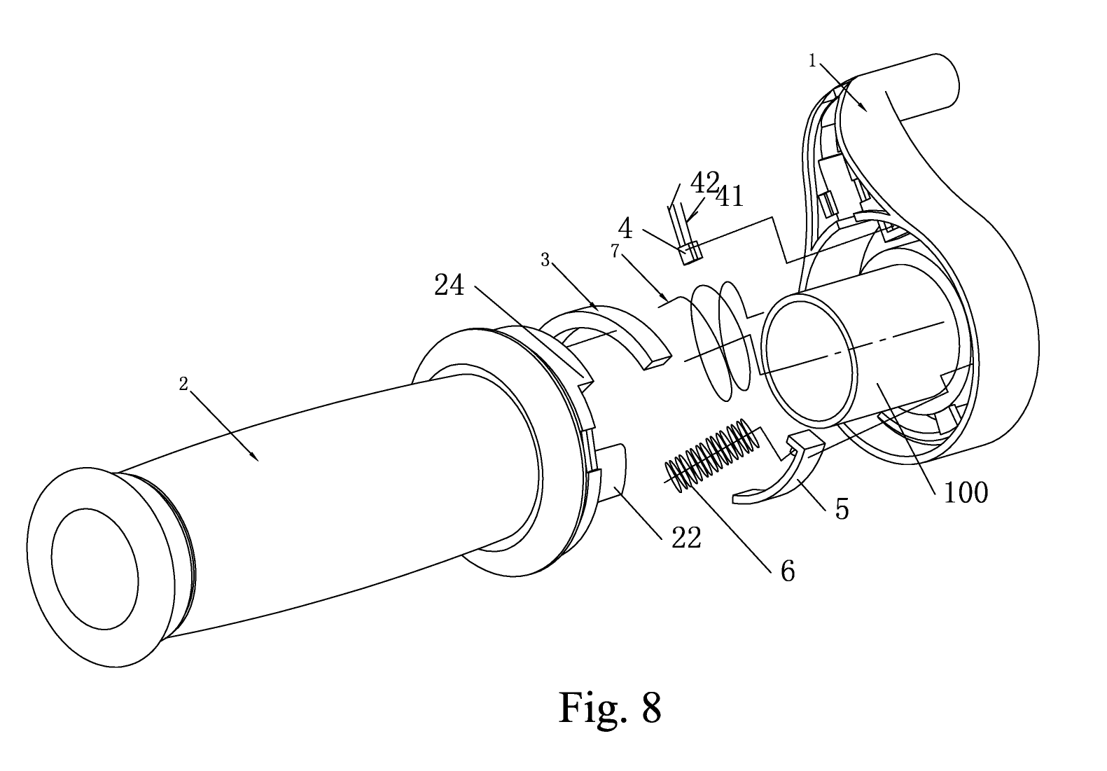

As showed in FIGS. 7 and 8, the handle seat 1 axially facing the twist grip 2 has a circular groove 11. The circular groove 11, the twist grip, the bar handle, the arc magnetic steel are all coaxial. A forward position-limiting barrier 12, an arc spring seat 13 and a Hall-effect sensor 4 are provided at a bottom of the circular groove 11.

A reversed position-limiting barrier 14 protruding into the circular groove is provided at an outer lateral wall 15 of the circular groove. The arc magnetic steel 3 and the Hall-effect sensor 4 are respectively provided inside the arc-shaped body 24 of the twist grip and on the handle seat, facing against each other but with no contact. When the twist grip is rotated, the Hall-effect sensor moves relative to the arc permanent magnet, and detects different positions of the arc permanent magnet to output accordingly different signals. The Hall-effect sensor has a wiring harness consisting of three wires, wherein two wires are power source wires 41 which supply the Hall-effect sensor with a voltage of around DCSV, and one wire is a position signal output wire 42. The arc permanent magnet moves to the different positions relative to the Hall-effect sensor, and an output signal of the position signal output wire of the Hall-effect sensor is at a range of 0.8V-4.3V.

A slider 5 comprises a guiding portion 51 slidably contacting the outer lateral wall 15 of the circular groove, and a supporting portion 52 disposed along a radial direction of the circular groove. The guiding portion 51 is provided between the outer lateral wall 15 of the circular groove and the spring seat 13, and contacts with the outer lateral wall 15 and the spring seat 13. The slider 5 is able to slide around an axis of the circular groove along the outer lateral wall of the circular groove. A leftward rotation spring 6 (coiled compression spring) is provided between an end of the spring seat 131 and the supporting portion 52, wherein the end of the spring seat 131 faces against the supporting portion 52, for pushing the slider to move counter-clockwise within the circular groove until the supporting portion 52 contacts the reversed position-limiting barrier. In other words, the reversed position-limiting barrier restricts a limit position to which the slider is able to move counter-clockwise within the circular groove.

The boss 22 and the arc magnetic steel 3 in the arc-shaped body 24 are inserted into the circular groove 11, and located between the supporting portion 52 and the forward position-limiting barrier 12.

A rightward rotation spring 7 is a torsion spring whose one end is mounted on the bar handle and the other end is mounted on the boss. The torsion spring 7 gives the twist grip a tendency to rotate clockwise relative to the bar handle, so the boss contacts the supporting portion under an effect of the torsion spring. Without applying nay external force onto the twist grip, the twist grip is at the idle position, wherein the left rotation spring drives a left side of the slider to contact a right side of the reversed position-limiting barrier, and meanwhile, the right rotation spring drives a right side of the boss to contact the left side of the slider. As showed in FIG. 4, at the idle position, the Hall-effect sensor is at a middle position of the arc magnetic steel. When the twist grip is at the idle position, the Hall-effect sensor outputs a DC2.5V signal as a reference signal to a controller.

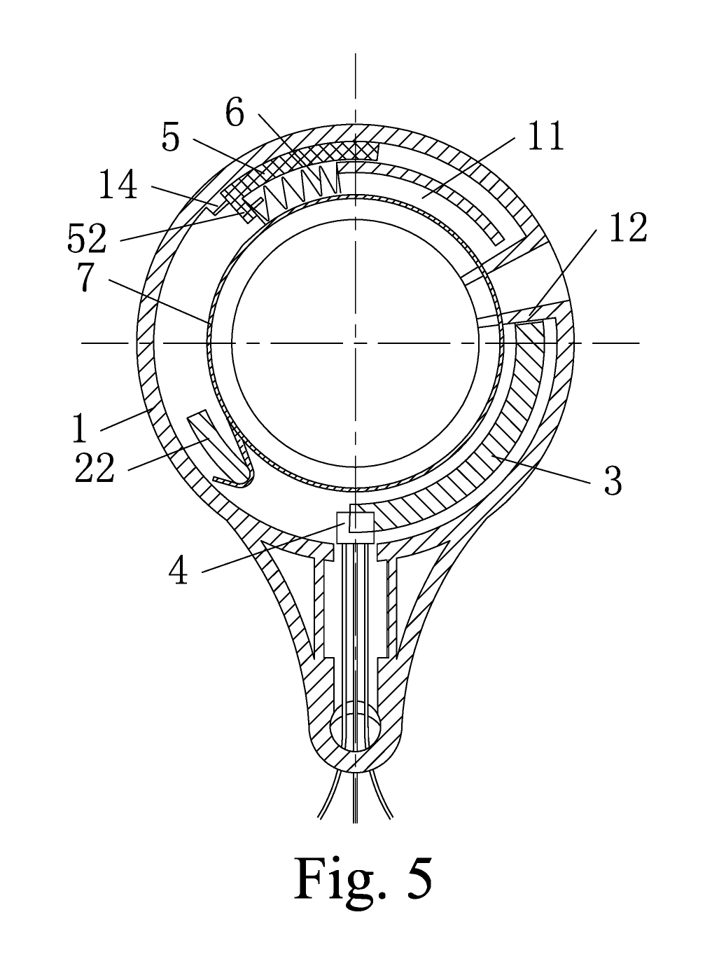

As showed in FIG. 5, in order to drive the electric vehicle to move forward, a counter-clockwise torque is applied onto the twist grip to rotate the twist grip counter-clockwise; the twist grip rotates counter-clockwise against a resilience of the rightward rotation spring and leaves the idle position. Herein, the slider remains stationary (the slider always contacts the reversed position-limiting barrier under the effect of the leftward rotation spring). With a rotation angle of the twist grip (relative to the idle position) increases, the arc magnet steel gradually moves (rotating counter-clockwise) relative to the Hall-effect sensor; the output signal of the Hall-effect sensor gradually increases from 2.5V. When the arc-shaped body 24 contacts the forward position-limiting barrier 12 in a circumferential direction, the twist grip is no longer able to rotate counter-clockwise any further. Herein, the Hall-effect sensor is at a left end of the arc magnetic steel; the output signal of the Hall-effect sensor reaches a maximum of 4.3V. The controller controls the motor to output larger torque according to the increase of the output signal of the Hall-effect sensor, so that the electric vehicle gradually speeds up in moving forward. When the external force is canceled, the twist grip rotates clockwise under the effect of the rightward rotation spring, and arrives at the idle position when the boss contacts the slider.

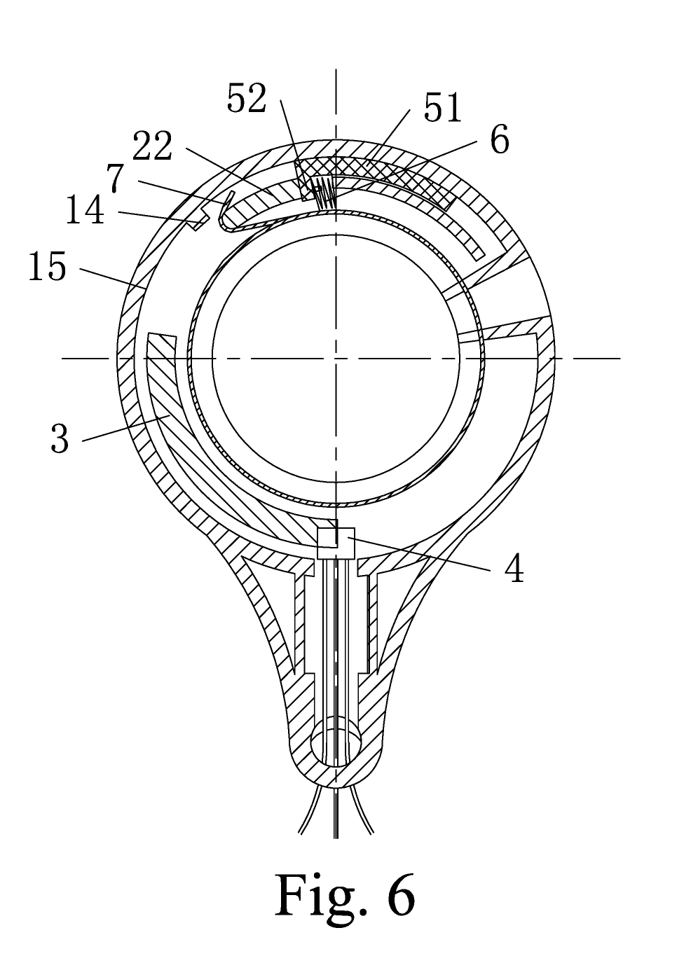

As showed in FIG. 6, in order to drive the electric vehicle to move backward or brake the electric vehicle which is moving forward, a clockwise torque is applied onto the twist grip to rotate the twist grip clockwise; the twist grip rotates clockwise against a resilience of the leftward rotation spring. In the meantime, the boss of the twist grip pushes the slider to detach the slider from the reversed position-limiting barrier; the slider moves clockwise within the circular groove. With the rotation angle of the twist grip (relative to the idle position) gradually increases, the leftward rotation spring 6 between the supporting portion and the spring seat is gradually compressed; the arc magnet steel gradually moves (rotating clockwise) relative to the Hall-effect sensor; and the output signal of the Hall-effect sensor gradually decreases from 2.5V. When the leftward rotation spring 6 can not be compressed any more, the twist grip is disenable to rotate clockwise any further; the Hall-effect sensor is at a right end of the arc magnetic steel; and the output signal of the Hall-effect sensor reaches a minimum of 0.8V. The controller controls the motor to output larger backward torque according to the decrease of the output signal of the Hall-effect sensor, so that the electric vehicle gradually speeds up in moving backward or brakes during moving forward. When the external force is canceled, the slider overcomes the resilience of the rightward rotation spring under the effect of the leftward rotation spring, and pushes the boss to rotate counter-clockwise within the circular groove. The twist grip arrives at the idle position when the slider contacts the reversed position-limiting barrier (and also the boss).

### Second Preferred Embodiment

A second preferred embodiment differs from the first preferred embodiment in that: when the arc permanent magnet rotates to different positions relative to the Hall-effect sensor, the output signal of the Hall-effect sensor is a pulse width modulation signal having a duty cycle of 5%-95%. At the idle position, the output signal of the Hall-effect sensor (the reference signal) has the duty cycle of around 50%.

In order to drive the electric vehicle to move forward, the counter-clockwise torque is applied onto the twist grip to rotate the twist grip counter-clockwise. With the rotation angle of the twist grip (relative to the idle position) gradually increases, the duty cycle of the output signal of the Hall-effect sensor gradually increases from 50%. When the arc-shaped body 24 contacts the forward position-limiting barrier 12 in the circumferential direction, the twist grip is no longer to rotate counter-clockwise any further; the duty cycle of the output signal of the Hall-effect sensor reaches a maximum of 95%. The controller controls the motor to output larger torque according to the increase of the duty cycle of the output signal of the Hall-effect sensor, so that the electric vehicle gradually speeds up in moving forward.

In order to drive the electric vehicle to move backward or brake during moving forward, the clockwise torque is applied on to the twist grip to rotate the twist grip clockwise. With the rotation angle of the twist grip (relative to the idle position) gradually increase, the duty cycle of the output signal of the Hall-effect sensor gradually decreases from 50%. When the leftward rotation spring 6 can not be compressed any more, the twist grip is forbidden to rotate clockwise any further; the duty cycle of the output signal of the Hall-effect sensor reaches a minimum of 5%. The controller controls the motor to output larger backward torque according to the decrease of the duty cycle of the output signal of the Hall-effect sensor, so that the electric vehicle gradually speeds up in moving backward or brakes during moving forward.

### Third Preferred Embodiment

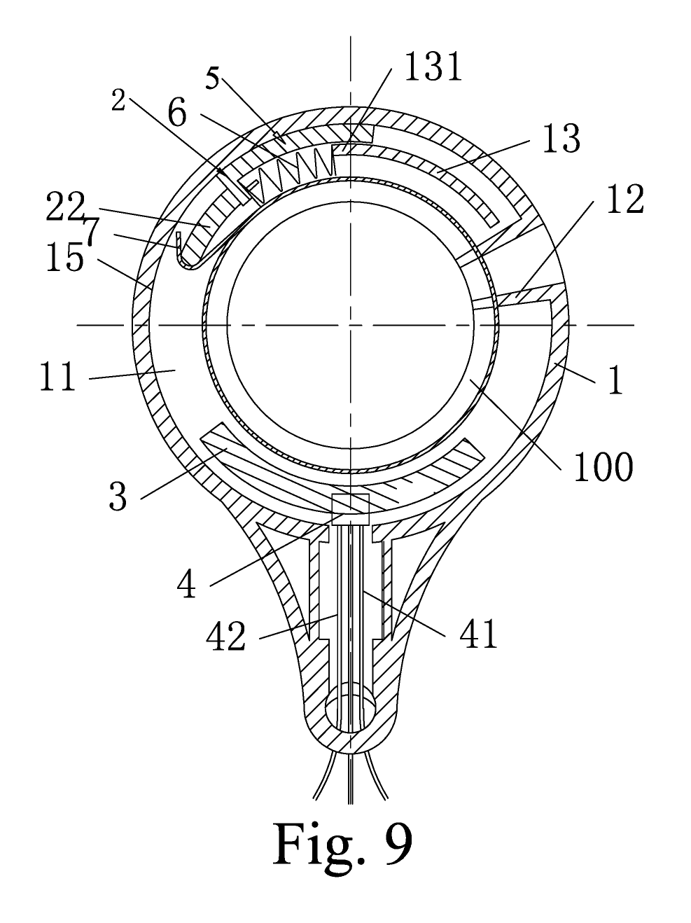

Referring to FIG. 9 (and FIGS. 5 and 6), a third preferred embodiment differs from the first preferred embodiment in that: no reversed position-limiting barrier 14, in the first preferred embodiment, is provided the outer lateral wall 15 of the circular groove in the third preferred embodiment; the twist grip 2 and the slider 5 are integrated together (the slider 5 can be regarded as a part of the twist grip 2) in the third preferred embodiment. Under a common effect of the leftward rotation spring and the rightward rotation spring, the twist grip is at the idle position. When the twist grip is rotated, the twist grip and the slider rotate together.

### Fourth Preferred Embodiment

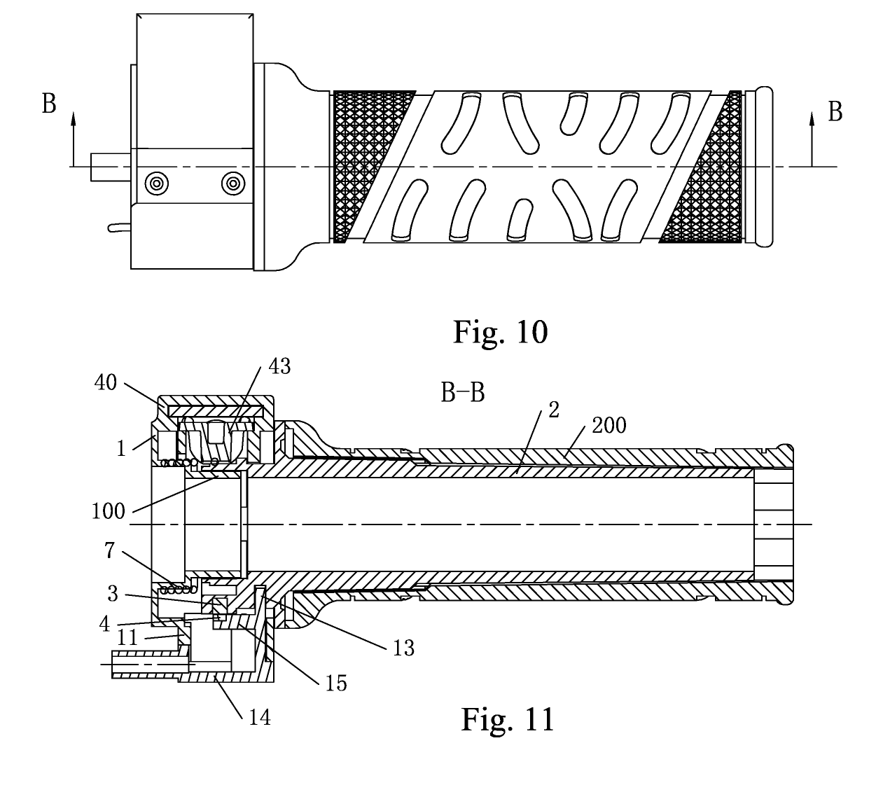

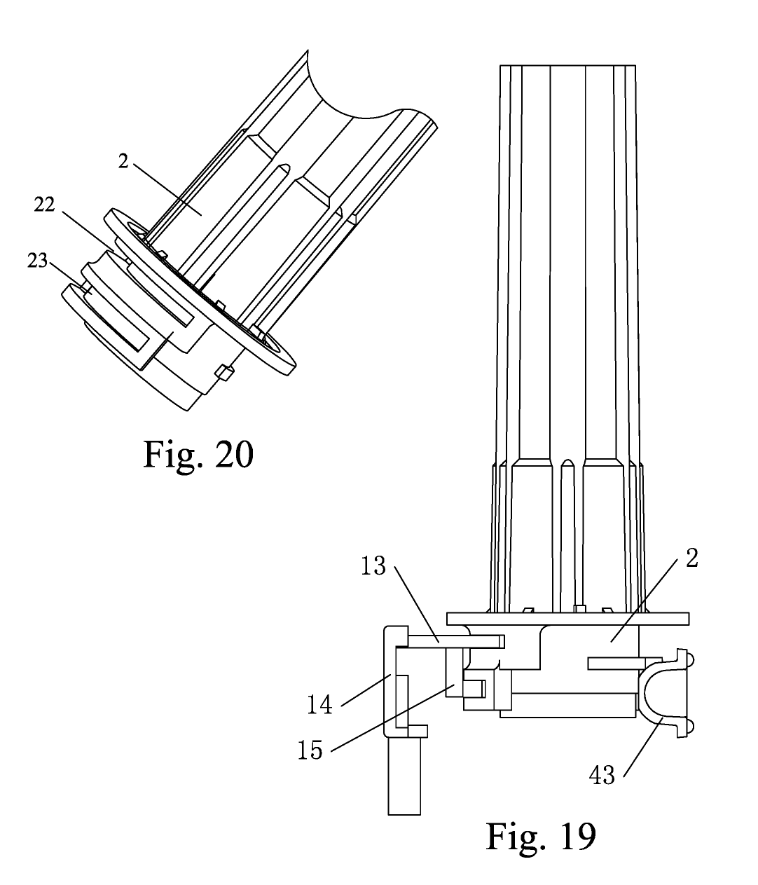

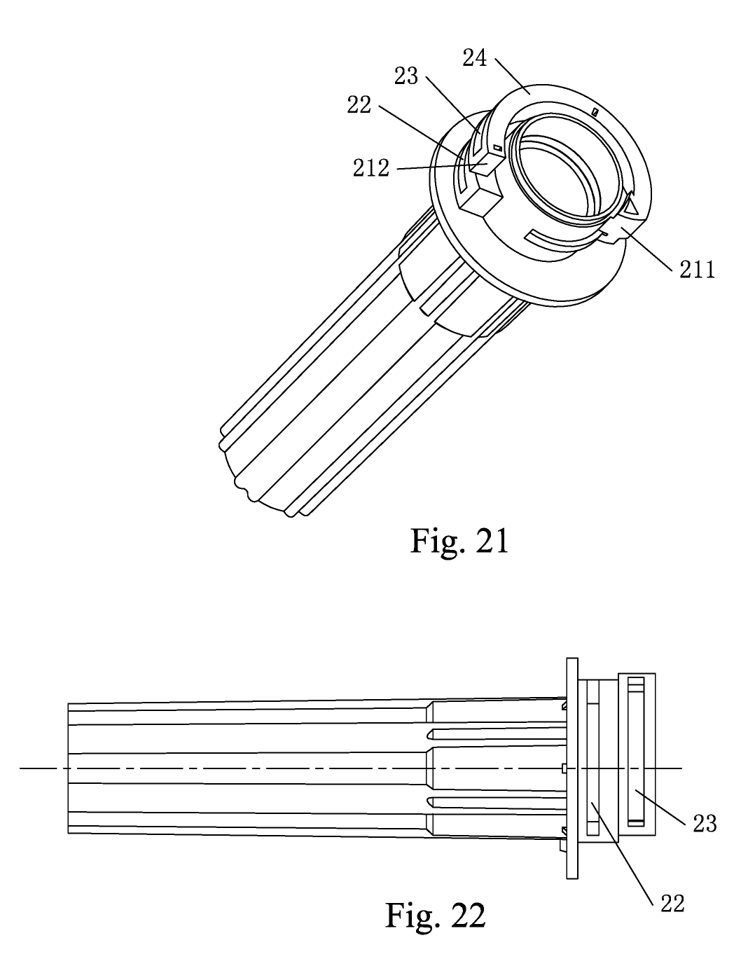

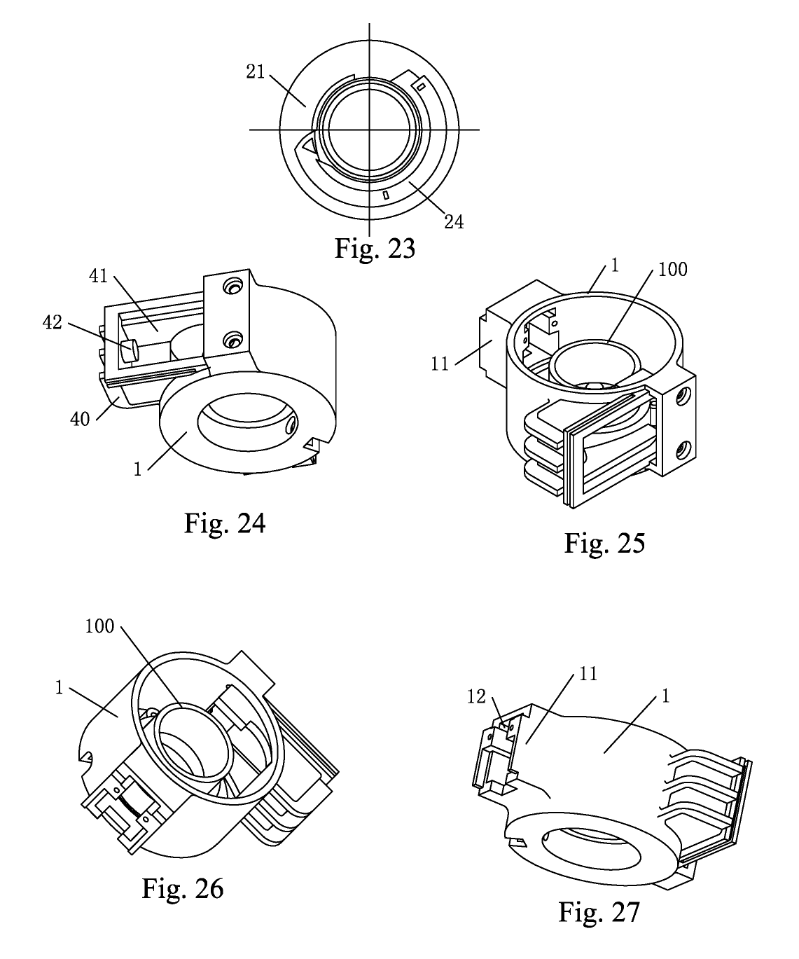

Referring to FIGS. 10-27, according to a fourth preferred embodiment of the present invention, a forward and backward speed adjusting handle for electric vehicles comprises a bar handle 100, a fixing element formed by a handle seat 1 mounted on the bar handle 100, a twist grip rotatably provided on the bar handle 100, and a grip sleeve 200 sleeved onto the twist grip 2.

An arch-shaped body 24 having a first arc groove 23, an arc position-limiting groove 22, and a second arc groove 21 are provided at an outer periphery of the twist grip 2. The second arc groove 21 and the arc position-limiting groove 22 are both coaxial with the twist grip, but at different sections of the twist grip. The second arc groove 21 and the arc-shaped body 24 are at the same section of the twist grip. The first arc groove 23 is for containing an arc permanent magnet 3. The arc permanent magnet 3 has a central angle of around 100°.

The arc position-limiting groove 22 has two inner end faces 221 and 222, wherein the two inner end faces 221 and 222 are at two ends along a circumferential direction of the twist grip. The second arc groove 21 has two inner end faces 211 and 212 which are at two ends along the circumferential direction of the twist grip. A spring seat 40 is provided on the handle seat 1 along a tangent direction of the twist grip; the spring seat 40 internally has a sliding groove 41 (spring cavity) arranged at a direction vertical to an axis of the twist grip; a slider 43 is able to slide relative to the sliding groove; one end of the sliding groove is communicated with the second arc groove 21. A leftward rotation spring (coiled compression spring) 6 is within the sliding groove; an axis of the leftward rotation spring is vertical to the axis of the twist grip; one end of the coiled compression spring is mounted at a protrusion 42 of the spring seat, and the other end of the coiled compression spring contacts the slider 43. At the other end of the sliding groove, distal to the protrusion 42, the handle seat has a thrust surface (restricting element) 16 for restricting a maximal sliding distance of the slider relative to the spring seat. The two ends of the coiled compression spring are respectively biased against the protrusion 42 and the slider 43. When the twist grip is at the idle position, the coiled compression spring drives a left-upper part of the slider to contact the thrust surface 16, and meanwhile the rightward rotation spring drives the inner end face 211 of the second arc groove 21 to contact a left-lower part of the slider.

The inner end face 211 of the second arc groove 21 which contacts the slider is a curved surface. The curved surface has such a structure to satisfy that: when the twist grip is applied with an external force, the twist grip rotates clockwise away from the idle position; the inner end face 211 of the second arc groove 21 pushes the slider to move rightward against the resilience of the coiled compression spring, wherein contacting points between the curved surface and the slider are at the axis of the coiled compression spring. The slider is always tangent to the inner end face 211 of the second arc groove. Therefore, the inner end face 211 of the second arc groove always pushes the slider 43 to slide along the sliding groove in the direction of the axis of the coiled compression spring; the slider is protected from being turned by any force deviated from the direction of the axis of the coiled compression spring, which improves a smooth slide of the slider relative to the inner end face 211 of the second arc groove.

A clamping frame 11 extending in a radial direction of the twist grip is provided on the handle seat 1; the clamping frame 11 has a through-hole 12 running in the radial direction of the twist grip. A position-limiting block 13 has a distal end, relative to the axis of the twist grip, mounted on a through-hole cover 14. A side of the position-limiting block 13 is connected to a sensor seat 15; the Hall-effect sensor 4 is mounted on the sensor seat 15.

The through-hole cover 14 is detachably connected to the clamping frame 11 through screws. The position-limiting block and the sensor seat cross through the through-hole. The position-limiting block 13 has a proximal end, relative to the axis of the twist grip, inserted into the arc position-limiting groove. When the twist grip rotates counter-clockwise at a maximal angle away from the idle position under the external force, the position-limiting block 13 and the inner end face 221 of the arc position-limiting groove contact the twist grip, and forbid the twist grip to rotate counter-clockwise any further. When the twist grip rotates clockwise at a maximal angle away from the idle position under the external force, the position-limiting block and the inner end face 222 of the arc position-limiting groove contact the twist grip, and forbid the twist grip to rotate clockwise any further. The arc position-limiting groove and the position-limiting block form a position-limiting device.

The Hall-effect sensor 4, mounted on the sensor seat, and the arc permanent magnet 4 face against each other in the radial direction of the twist grip.

The rightward rotation spring is a torsion spring 7 whose one end is mounted on an end face of the twist grip and the other end is mounted on the handle seat facing against the end face of the twist grip. The coiled compression spring 6 and the torsion spring 7 have such stiffness that an external force for rotating the twist grip counter-clockwise away from the idle position is smaller than an external force for rotating the twist grip clockwise away from the idle position.

The Hall-effect sensor has a wiring harness consisting of three wires, wherein two are power supply wires for supplying the Hall-effect sensor with a voltage around DC5V and one is a position signal output wire. When the arc permanent magnet moves to the different positions relative to the Hall-effect sensor, an output signal of the position signal output wire of the Hall-effect sensor is at a range of 0.8V-4.3V.

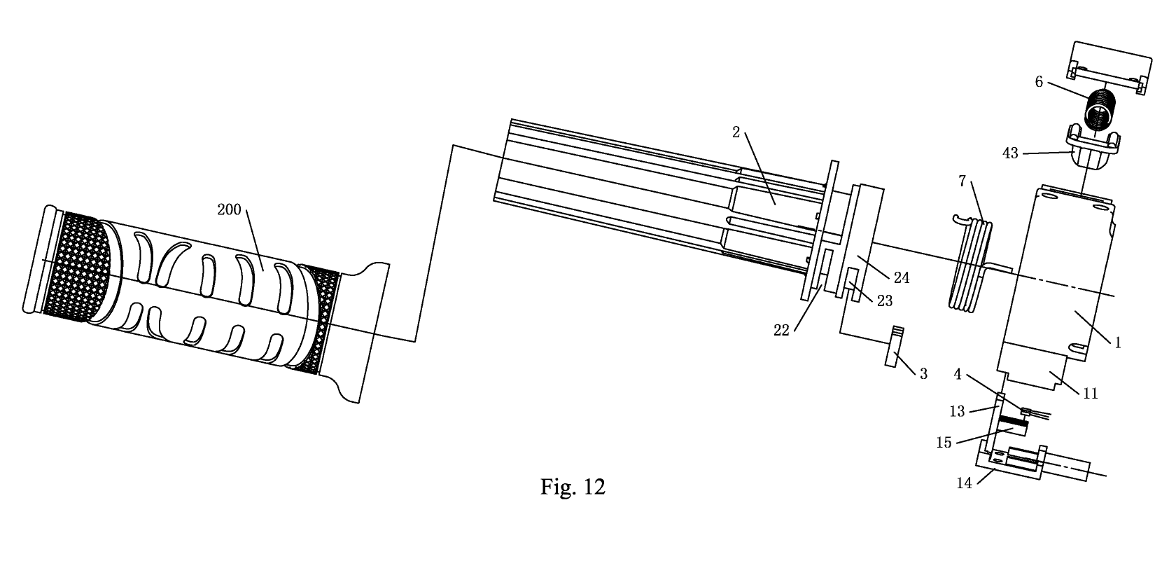

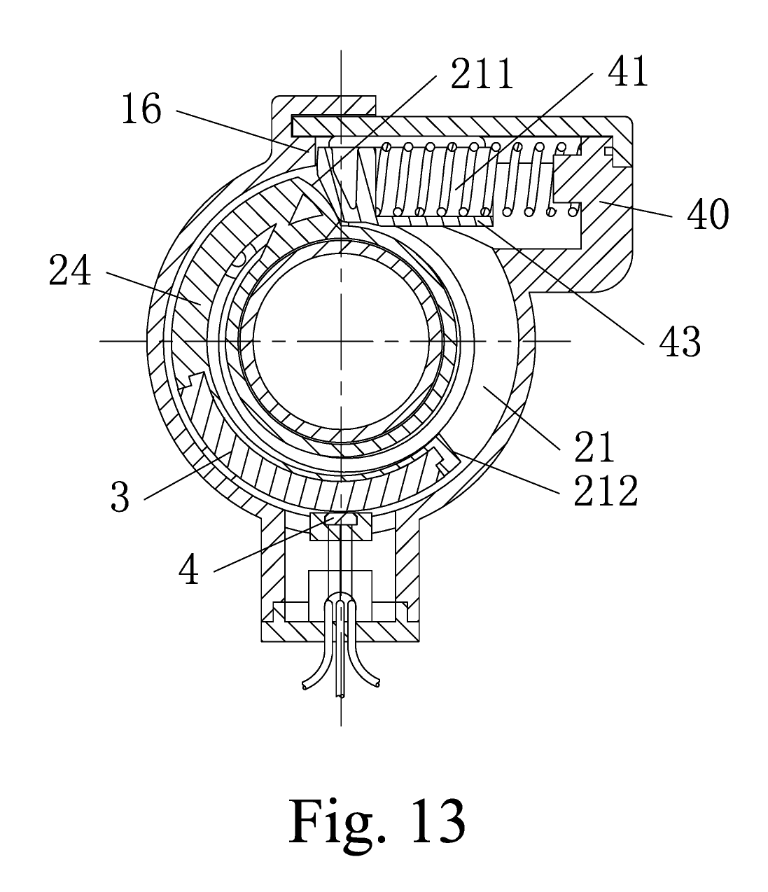

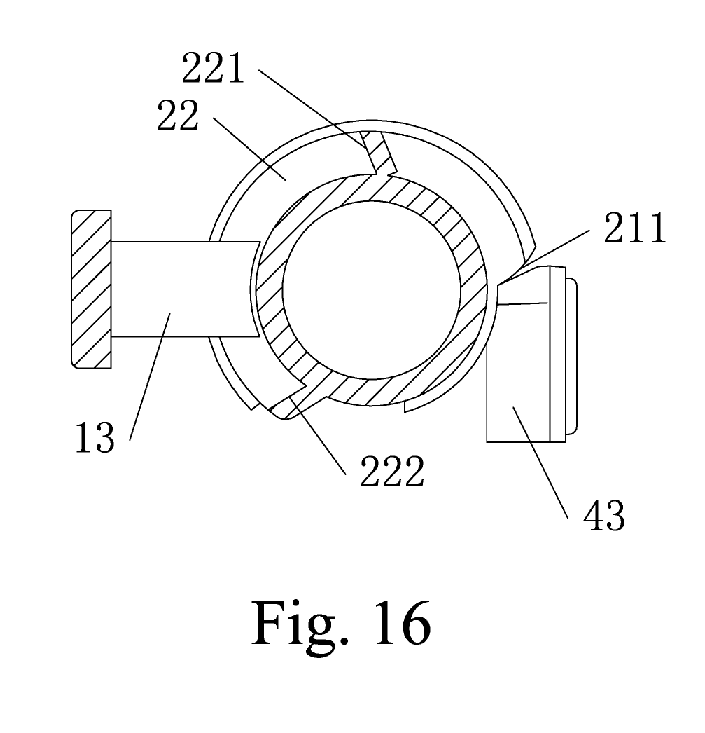

The coiled compression spring 6 pushes the inner end face 211 of the second arc groove through the slider, so as to drive the twist grip to rotate counter-clockwise relative to the bar handle. The torsion spring 7 drives the twist grip to rotate clockwise relative to the bar handle. Because a leftward resilience of the coiled compression spring 6 on the slider is larger than a rightward action force of the torsion spring on the slider, at the idle position as showed in FIGS. 13 and 16, an upper part of a left end of the slider is in contact with the thrust surface, and the torsion spring leads the inner end face 211 of the second arc groove to contact a lower part of the left end of the slider. When the twist grip is at the idle position, the Hall-effect sensor outputs a DC1.5V signal as a reference signal to a controller.

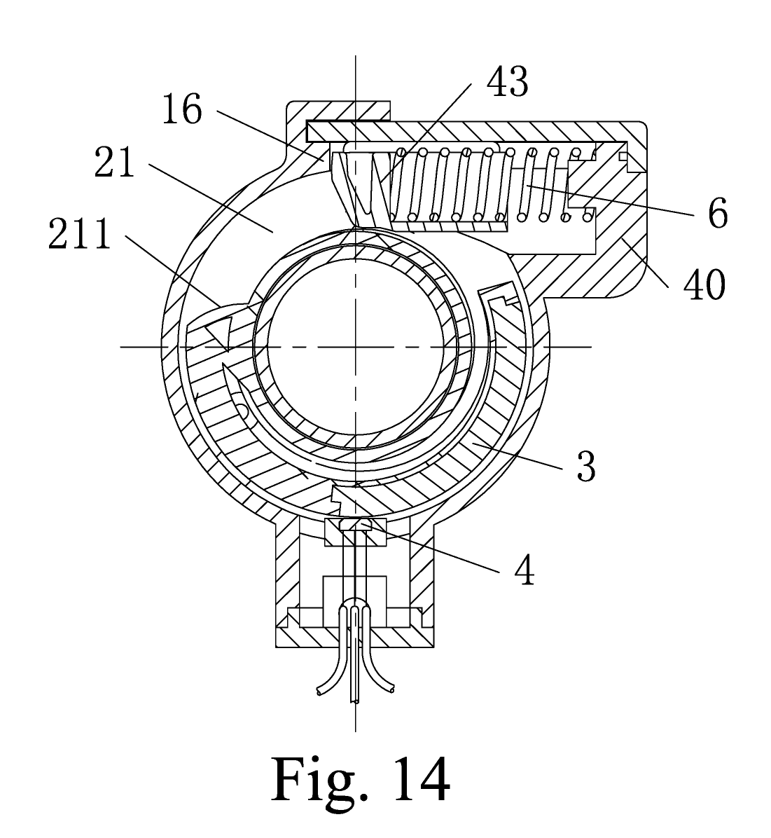

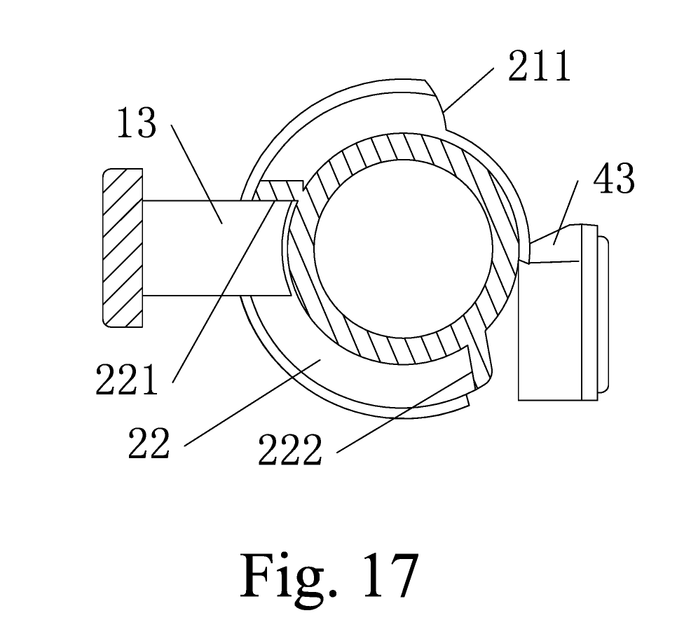

In order to rotate the twist grip counter-clockwise, a counter-clockwise torque (external force) is applied onto the twist grip; and then the twist grip rotates counter-clockwise against a force of the torsion spring, wherein the slider is in contact with the thrust surface under the effect of the coiled compression spring 6 and thus unable to move leftward. Therefore, the inner end face 211 of the second arc groove is detached from the slider; by continuing rotating the twist grip counter-clockwise until the position-limiting block contacts the inner end face 221 of the arc position-limiting groove, the twist grip is rotated at the maximal angle, as showed in FIGS. 14 and 17. With a rotation angle of the twist grip which is rotating counter-clockwise (relative to the idle position) increases, the arc permanent magnet gradually moves (rotating counter-clockwise) relative to the Hall-effect sensor, and the output signal of the Hall-effect sensor gradually increases from 1.5V. When the twist grip is unable to rotate counter-clockwise any further, the Hall-effect sensor is at a left end of the arc magnetic steel, and the output signal of the Hall-effect sensor reaches a maximum of 4.3V. When the external force for rotating the twist grip counter-clockwise is canceled, under the effect of the torsion spring, the twist grip rapidly rotates clockwise; when the inner end face 211 of the second arc groove contacts the slider, the twist grip recovers to be at the idle position and stops rotating.

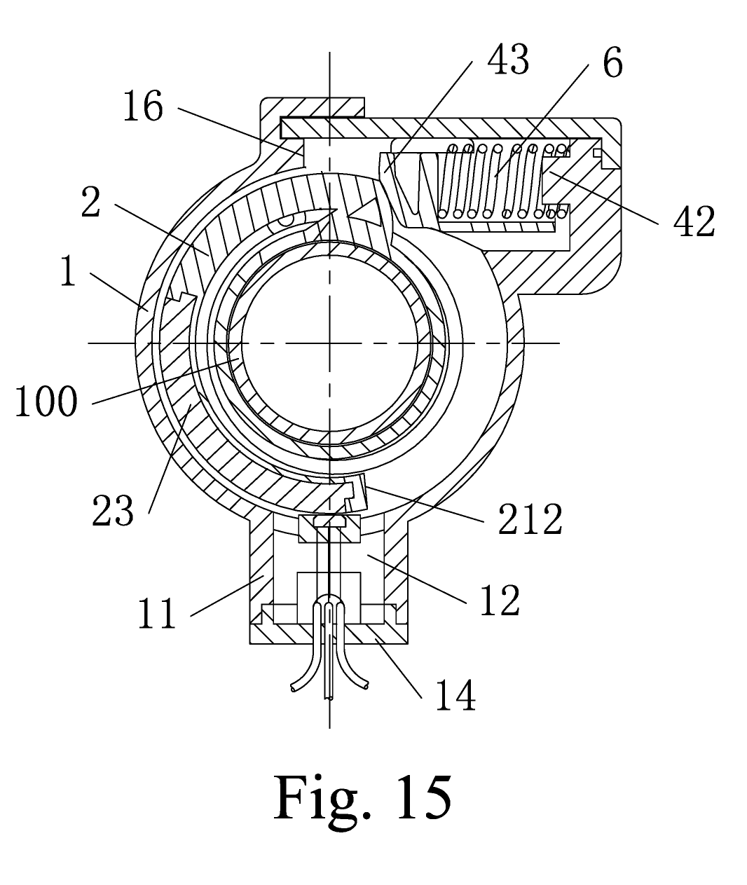

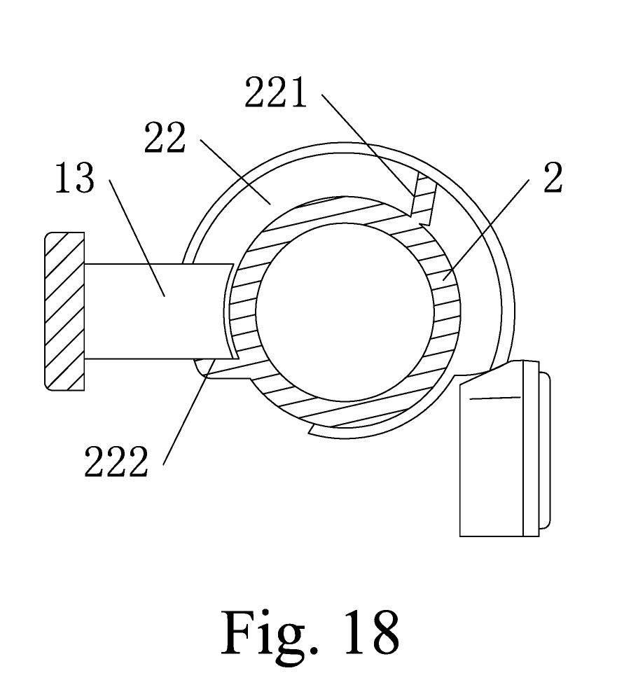

In order to rotate the twist grip clockwise, a clockwise torque (external force) is applied on the twist grip, and the inner end face 221 of the arc position-limiting groove pushes the slider. As a result, the slider moves rightward against a resilience of the coiled compression spring, in such a manner that the coiled compression spring 6 is gradually compressed. When the position-limiting block contacts the inner end face 222 of the arc position-limiting groove, the twist grip is rotated clockwise at the maximal angle, as showed in FIGS. 15 and 18; and meanwhile, the inner end face 211 of the second arc groove always contacts the slider under the effect of the torsion spring. With the rotation angle of the twist grip which is rotating clockwise (relative to the idle position) increases, the arc permanent magnet gradually moves (rotating clockwise) relative to the Hall-effect sensor, and the output signal of the Hall-effect sensor gradually decreases from 1.5V. When the twist grip is unable to rotate clockwise any further, the Hall-effect sensor is at a right end of the arc magnetic steel, and the output signal of the Hall-effect sensor reaches a minimum of 0.8V. When the external force for rotating the twist grip clockwise is canceled, the coiled compression spring 6 pushes the slider to move leftward, and the slider pushes the inner end face 211 of the second arc groove. Thus, the twist grip rapidly rotates counter-clockwise; when the slider contacts the thrust surface again, the twist grip is stabilized at the idle position.

### Fifth Preferred Embodiment

Compared with the fourth preferred embodiment, a fifth preferred embodiment excludes the thrust surface (restricting element) for restricting the maximal sliding distance of the slider relative to the spring seat. In other words, in the fifth preferred embodiment, the slider is able to slide leftward and rightward freely without restriction. Referring to FIGS. 13-18, the fifth preferred embodiment has the following operations.

The coiled compression spring 6 pushes the inner end face 211 of the second arc groove through the slider, in such a manner that the twist grip is rotated counter-clockwise relative to the bar handle. The torsion spring 7 drives the twist grip to rotate clockwise relative to the bar handle. Under a common effect of the leftward rotation spring and the rightward rotation spring, the twist grip is at the idle position, as showed in FIGS. 13 and 16. When the twist grip is at the idle position, the Hall-effect sensor outputs the DC1.5V signal as the reference signal to the controller.

In order to rotate the twist grip counter-clockwise, the counter-clockwise torque (external force) is applied onto the twist grip, and then the twist grip rotates counter-clockwise against the force of the torsion spring, wherein the slider gradually moves leftward under the effect of the coiled compression spring 6. By continuing rotating the twist grip counter-clockwise, the resilience of the coiled compression spring 6 is gradually released (recovering from a compressed state to a natural state without compression). When the coiled compression spring 6 recovers the natural state, the slider stops moving. By continuing rotating the twist grip counter-clockwise until the position-limiting block contacts the inner end face 221 of the arc position-limiting groove, the twist grip is rotated counter-clockwise at the maximal angle, as showed in FIGS. 14 and 17. With the rotation angle of the twist grip which is rotating counter-clockwise (relative to the idle position) increases, the arc permanent magnet gradually moves (rotating counter-clockwise) relative to the Hall-effect sensor, and the output signal of the Hall-effect sensor gradually increases from 1.5V. When the twist grip is unable to rotate counter-clockwise any further, the Hall-effect sensor is at the left end of the arc magnetic steel, and the output signal of the Hall-effect sensor reaches the maximum of 4.3V. When the external force for rotating the twist grip counter-clockwise is canceled, under the effect of the torsion spring, the twist grip rapidly rotates clockwise. After the inner end face 211 of the second arc groove contacts the slider, the slider is pushed by the twist grip to move rightward, thereby compressing the coiled compression spring. When an action force on the slider by the coiled compression spring is equal to an action force on the slider by the torsion spring, the twist grip is stabilized at the idle position.

In order to rotate the twist grip clockwise, the clockwise torque (external force) is applied onto the twist grip, and then the inner end face 221 of the arc position-limiting groove pushes the slider, in such a manner that the slider moves rightward against the resilience of the coiled compression spring and the coiled compression spring 6 is gradually compressed. When the position-limiting block contacts the inner end face 222 of the arc position-limiting groove, the twist grip is rotated clockwise at the maximal angle, as showed in FIGS. 15 and 18. With the rotation angle of the twist grip which is rotating clockwise (relative to the idle position) increases, the arc permanent magnet gradually moves relative to the Hall-effect sensor (rotating clockwise), and the output signal of the Hall-effect sensor gradually decreases from 1.5V. When the twist grip is unable to rotate clockwise any further, the Hall-effect sensor is at the right end of the arc magnetic steel, and the output signal of the Hall-effect sensor reaches the minimum of 0.8V. When the external force for rotating the twist grip clockwise is canceled, the coiled compression spring 6 pushes the slider to move leftward, and then the slider pushes the inner end face 211 of the second arc groove. As a result, the twist grip rapidly rotates counter-clockwise. When the action force on the slider by the coiled compression spring is equal to the action force on the slider by the torsion spring, the twist grip is stabilized at the idle position.

The present invention discloses the forward and backward speed adjusting handle for the electric vehicles. When the twist grip is at the idle position, the Hall-effect sensor is close to the arc magnetic steel at some position between the two ends of the arc magnetic steel. When the twist grip rotates forward or backward, the Hall-effect sensor remains stationary while the arc magnetic steel rotates, thereby changing the output signal of the Hall-effect sensor. The output signal is outputted into the controller which controls changes in a value and a direction of the torque of the motor according to the output signal. When the twist grip is no longer able to rotate clockwise or counter-clockwise, the Hall-effect sensor is close to the arc magnetic steel at one of the two ends of the arc magnetic steel. When the twist grip is loosened, the arc magnetic steel returns to the idle position under the effect of the springs.

The forward and backward speed adjusting handle of the present invention adjusts speed forward and backward, omits a reversing switch in conventional electric vehicles, enhances product reliability and reduces costs.

1. A forward and backward speed adjusting handle for an electric vehicle, comprising: a bar handle, a fixing element formed by a handle seat mounted on said bar handle, and a twist grip rotatably provided on said bar handle, wherein: a leftward rotation spring and a rightward rotation spring are provided between said fixing element and said twist grip; said leftward rotation spring drives said twist grip to rotate counter-clockwise relative to said bar handle, and said rightward rotation spring drives said twist grip to rotate clockwise relative to said bar handle; under a common effect of said leftward rotation spring and said rightward rotation spring, said twist grip is at an idle position; said twist grip rotates clockwise or counter-clockwise away from said idle position when said twist grip is applied with an external force; and
further comprising a Hall-effect sensor and an arc permanent magnet which are respectively provided on said twist grip and said fixing element, facing against each other but without contact, wherein: when said twist grip rotates, said Hall-effect sensor moves relative to said arc permanent magnet, detects different positions of said arc permanent magnet and accordingly outputs different signals.

2. The forward and backward speed adjusting handle for the electric vehicle, as recited in claim 1, wherein: said arc permanent magnet is coaxial with said twist grip; one of said arc permanent magnet and said Hall-effect sensor is provided on an end face of said twist grip, and the other one of said arc permanent magnet and said Hall-effect sensor is provided on said handle seat; said Hall-effect sensor and said arc permanent magnet face against each other in a direction parallel with an axis of said twist grip.

3. The forward and backward speed adjusting handle for the electric vehicle, as recited in claim 1, wherein: said arc permanent magnet is coaxial with said twist grip; one of said arc permanent magnet and said Hall-effect sensor is provided at an outer periphery of said twist grip, and the other one of said arc permanent magnet and said Hall-effect sensor is provided on said handle seat; said Hall-effect sensor and said arc permanent magnet face against each other in a direction vertical to an axis of said twist grip.

4. The forward and backward speed adjusting handle for the electric vehicle, as recited in claim 1, wherein: said leftward rotation spring and said rightward rotation spring have such a stiffness that the external force for rotating said twist grip counter-clockwise away from said idle position is smaller than the external force for rotating said twist grip clockwise away from said idle position.

5. The forward and backward speed adjusting handle for the electric vehicle, as recite in claim 1, wherein: an outer periphery of said twist grip has an arc groove coaxial with said twist grip; two inner end faces of said arc groove are at two ends in a circumferential direction of said twist grip; a spring seat is provided on said handle seat, and said leftward rotation spring is a coiled compression spring; an axis of said coiled compression spring is vertical to an axis of said twist grip; one end of said coiled compression spring is biased against said spring seat, and the other end of said coiled compression spring contacts with one of said two inner end faces of said arc groove.

6. The forward and backward speed adjusting handle for the electric vehicle, as recited in claim 5, wherein: said handle seat has a sliding groove arranged along a direction of said axis of said coiled compression spring, and a slider is slidably provided within said sliding groove; said sliding groove is communicated with said arc groove; a restricting element, for restricting a maximal sliding distance of said slider relative to said spring seat, is provided within said sliding groove; two ends of said coiled compression spring are respectively biased against said spring seat and said slider; when said twist grip is at said idle position, said leftward rotation spring drives said slider to contact said restricting element, and said rightward rotation spring drives a first inner end face of said arc groove to contact said slider.

7. The forward and backward speed adjusting handle for the electric vehicle, as recited in claim 6, wherein: said first inner end face of said arc groove which contacts said slider is a curved surface; when said twist grip is applied with the external force, said twist grip is rotated, and then said first inner end face of said arc groove pushes said slider to move; said curved surface contacts said slider at contacting points which are at said axis of said coiled compression spring.

8. The forward and backward speed adjusting handle for the electric vehicle, as recited in claim 5, further comprising a position-limiting device for restricting a maximal angle at which said twist grip is able to rotate counter-clockwise away from said idle position and a maximal angle at which said twist grip is able to rotate clockwise away from said idle position.

9. The forward and backward speed adjusting handle for the electric vehicle, as recited in claim 8, wherein: said position-limiting device comprises an arc position-limiting groove and a position-limiting block; said handle seat has said arc position-limiting groove which is coaxial with said twist grip; two inner end faces of said arc position-limiting groove are at two ends in said circumferential direction of said twist grip; said position-limiting block which is inserted into said arc position-limiting groove in a radial direction of said twist grip is provided at said outer periphery of said twist grip; when said twist grip is rotated counter-clockwise at said maximal angle away from said idle position under the external force, said position-limiting block contacts one inner end face of said arc position-limiting groove, thereby forbidding said twist grip to rotate counter-clockwise; when said twist grip is rotated clockwise at said maximal angle away from said idle position under the external force, said position-limiting block contacts the other inner end face of the said arc position-limiting groove, thereby forbidding said twist grip to rotate clockwise.

10. The forward and backward speed adjusting handle for the electric vehicle, as recited in claim 8, wherein: said position-limiting device comprises an arc position-limiting groove and a position-limiting block; said outer periphery of said twist grip has said arc position-limiting groove which is coaxial with said twist grip; two inner end faces of said arc position-limiting groove are at two ends in said circumferential direction of said twist grip; said position-limiting block which is inserted into said arc position-limiting groove in a radial direction of said twist grip is provided on said handle seat; when said twist grip is rotated counter-clockwise away from said idle position at said maximal angle under the external force, said position-limiting block contacts one inner end face of said arc position-limiting groove, thereby forbidding said twist grip to rotate counter-clockwise; when said twist grip is rotated clockwise away from said idle position at said maximal angle under the external force, said position-limiting block contacts the other inner end face of said arc position-limiting groove, thereby forbidding said twist grip to rotate clockwise.

11. The forward and backward speed adjusting handle for the electric vehicle, as recited in claim 10, wherein: said handle seat has a through-hole in said radial direction of said twist grip; said position-limiting block is detachably connected to the through-hole, and runs into said arc position-limiting groove through said through-hole.

12. The forward and backward speed adjusting handle for the electric vehicle, as recited in claim 11, wherein: said arc permanent magnet is provided at said outer periphery of said twist grip; said arc permanent magnet and said arc position-limiting groove are at different sections of said twist grip; a sensor seat is connected to said position-limiting block, and said Hall-effect sensor is mounted on said sensor seat; said position-limiting block and said sensor seat cross through said through-hole; said Hall-effect sensor and said arc permanent magnet face against each other in a direction vertical to said axis of said twist grip.

13. The forward and backward speed adjusting handle for the electric vehicle, as recited in claim 1, wherein: a boss is provided at an end face of said twist grip, and said handle seat has a circular groove where said boss is inserted; said circular groove is coaxial with said twist grip; a slider which is able to slide around an axis of said circular groove along said circular groove is provided within said circular groove; said leftward rotation spring, for pushing said slider to move counter-clockwise within said circular groove, is provided between said slider and a spring seat on a bottom of said circular groove; a reversed position-limiting barrier, for restricting a limit position to which said slider is able to move counter-clockwise within said circular groove, is provided at a lateral wall of said circular groove; when said twist grip is at said idle position, said leftward rotation spring drives said slider to contact said reversed position-limiting barrier, and said rightward rotation spring drives said boss to contact said slider.

14. The forward and backward speed adjusting handle for the electric vehicle, as recited in claim 13, wherein: said slider comprises a guiding portion, slidably contacting said lateral wall of said circular groove, and a supporting portion, disposed in a radial direction of said circular groove; said spring seat is arc-shaped; said guiding portion is provided between said lateral wall of said circular groove and said spring seat, and contacts said lateral wall of said circular groove and said spring seat; said leftward rotation spring is provided between an end of said spring seat and said supporting portion.

15. The forward and backward speed adjusting handle for the electric vehicle, as recited in claim 13, wherein: a forward position-limiting barrier is provided on said bottom of said circular groove; when said twist grip is rotated counter-clockwise away from said idle position at a certain angle under the external force, said forward position-limiting block contacts said twist grip, thereby forbidding said twist grip to rotate counter-clockwise; said certain angle is a maximal angle at which said twist grip is able to rotate counter-clockwise away from said idle position under the external force.

16. The forward and backward speed adjusting handle for the electric vehicle, as recited in claim 1, wherein: said arc permanent magnet has a central angle larger than 90°.

17. An electric vehicle power control device, comprising: said forward and backward speed adjusting handle for the electric vehicle as recited in claim 1, and a controller for controlling a motor which drives the electric vehicle, wherein: said controller is electrically connected to said Hall-effect sensor; said controller receives an output signal of said Hall-effect sensor, and controls said motor to output a counter-clockwise torque or a clockwise torque according to different output signals of said Hall-effect sensor.

18. The electric vehicle power control device, as recited in claim 17, wherein: when said twist grip is at said idle position, said output signal of said Hall-effect sensor is a reference signal T; given that said output signal of said Hall-effect sensor when said twist grip is at some position is R, said motor outputs no torque when T+T*5%≧R≧T−T*5%; a direction of said torque outputted by said motor when R>T+T*5% is opposite to a direction of said torque outputted by said motor when R<T−T*5%, a value of said torque outputted by said motor when R>T+T*5% increases along with R−(T+T*5%) increases; a value of said torque outputted by said motor when R<T−T*5% increase along with (T−T*5%)−R increases.
